(19) United States
(12) Patent Application Publication
(10) Pub. No.: US 2026/0367493 A1
(43) Pub. Date: Nov. 19, 2026

(54) SYSTEM AND METHOD FOR IMPROVING SEQUENTIAL COLOR SEPARATION FOR MULTI-LASER PHOSPHOR-BASED SYSTEM

(71) Applicant: Texas Instruments Incorporated, Dallas, TX (US)

(72) Inventors: Todd A Clatanoff, Allen, TX (US); Alexander Lyubarsky, Dallas, TX (US)

(21) Appl. No.: 19/665,229

(22) Filed: May 1, 2026

Related U.S. Application Data
(60) Provisional application No. 63/805,478, filed on May 14, 2025.

(51) Int. Cl. G03B 21/20; G02B 26/00

(52) U.S. Cl. CPC G03B 21/204; G02B 26/008; G03B 21/2013; G03B 21/2066; G03B 21/208

(57) ABSTRACT

In an example, an illumination system includes a laser-phosphor light source including a laser and a phosphor device, the laser configurable to emit, during one or more first time periods, laser light of a first color, and the phosphor device configurable to emit a phosphor emission of one or more second colors responsive to being illuminated by the laser light. The example illumination system further includes a supplemental light source configurable to produce, during one or more second time periods substantially non-overlapping with the one or more first time periods, first source light of the first color, a homogenizer operable to produce an illumination beam based on the phosphor emission and the first source light, and a dichroic mirror positioned to reflect the first source light to the homogenizer and to transmit second source light to the homogenizer, the second source light based on the phosphor emission.

### CROSS-REFERENCE TO RELATED APPLICATION

This application claims the benefit of and priority to U.S. Provisional Application No. 63/805,478 filed on May 14, 2025, which is herein incorporated by reference in its entirety.

### TECHNICAL FIELD

This description relates to projection display systems, and more particularly, to display systems employing laser-phosphor light sources.

### BACKGROUND

Projection display systems project images onto surfaces, such as onto a screen of the display system or an external surface, to display video or still pictures. Some projection display systems use a spatial light modulator that includes adjustable display elements, generally arranged in a matrix of rows and columns. The display elements form images with image location blocks, also referred to herein as pixels, on the screen or the surface where the image is projected. The display elements are adjusted by a controller to provide, based on color shades in the pixels of a displayed image, levels of brightness in the displayed image. The image data is also processed according to an image modulation scheme, such as pulse width modulation (PWM), to control the intensity and rate of the displayed images for proper viewing by a human eye.

### SUMMARY

In one example, an illumination system comprises: a laser-phosphor light source including a laser and a phosphor device, the laser configurable to emit, during one or more first time periods, laser light of a first color, and the phosphor device configurable to emit a phosphor emission of one or more second colors responsive to being illuminated by the laser light; a supplemental light source configurable to produce, during one or more second time periods substantially non-overlapping with the one or more first time periods, first source light of the first color, thereby eliminating time slots associated with at least some optical spokes. The example illumination system further comprises a homogenizer operable to produce an illumination beam based on the phosphor emission and the first source light; and a dichroic mirror positioned to reflect the first source light to the homogenizer and to transmit second source light to the homogenizer, the second source light based on the phosphor emission.

Another example is directed to a method of producing illumination light comprising a time-multiplexed sequence of a plurality of colors. The example method comprises: controlling a laser-phosphor light source to produce a first component of the illumination light during a plurality of first time periods, the first component of the illumination light including a first subset of the plurality of colors; and controlling a supplemental light source to produce a second component of the illumination light during a plurality of second time periods that are substantially non-overlapping with the first time periods, the second component of the illumination light including a second subset of the plurality of colors, the second subset including at least one color not present in the first subset; wherein the laser-phosphor light sources includes a laser; wherein controlling the laser-phosphor light source includes activating the laser to emit laser light for the plurality of first time periods and deactivating the laser for the plurality of second time periods; and wherein controlling the supplemental light source includes activating at least one emitter of the supplemental light source for the plurality of second time periods and deactivating the at least one emitter for the plurality of first time periods. In some examples, either or both of the plurality of first time periods and the plurality of second time periods include time periods of the same or different durations.

According to another example, a light projection system comprises an illumination subsystem configurable to produce an illumination beam, the illumination subsystem including a first laser configurable to emit first laser light, a phosphor device operable to produce a phosphor emission responsive being illuminated by the first laser light, a color filter operable to produce filtered light based on the phosphor emission from the phosphor device, and a second laser configurable to emit second laser light, the second laser being optically decoupled from the phosphor device and the color filter. The example light projection system further comprises a controller coupled to the first laser and to the second laser, the controller configurable to control the first laser to emit the first laser light for one or more first time periods and to deactivate the first laser for one or more second time periods, and to control the second laser to emit the second laser light for the one or more second time periods and to deactivate the second laser for the one or more first time periods, to thereby produce the illumination beam as a time-multiplexed combination of the second laser light and the filtered light.

### BRIEF DESCRIPTION OF THE DRAWINGS

FIG. 1 is a block diagram of a display system, according to an example.

FIG. 2A is a block diagram showing an arrangement of an illumination system that may be part of the display system of FIG. 1, according to an example.

FIG. 2B is a diagram illustrating an optical implementation of the illumination system of FIG. 2A, according to an example.

FIG. 3 is a diagram of a phosphor wheel, according to an example.

FIG. 4A is a diagram of a color filter wheel, according to an example.

FIG. 4B is a diagram of a color filter wheel, according to another example.

FIG. 5 is a timing diagram illustrating illumination output from various elements of the system of FIG. 2B, according to an example.

FIG. 6A is a block diagram showing another arrangement of the illumination system that may be part of the display system of FIG. 1, according to another example.

FIG. 6B is a diagram illustrating an optical implementation of the illumination system of FIG. 6A, according to an example.

FIG. 7 is a diagram of a color filter wheel, according to another example.

FIG. 8 is a timing diagram illustrating illumination output from various elements of the system of FIG. 6B, according to an example.

FIG. 9A is a diagram illustrating an illumination system that may be part of the display system of FIG. 1, according to another example.

FIG. 9B is a diagram illustrating an optical implementation of the illumination system of FIG. 9A, according to an example.

FIG. 10 is a flow diagram of a method of producing multi-color illumination light for a spatial modulator, according to an example.

### DETAILED DESCRIPTION

Techniques are described for reducing optical spokes in pulse width modulation (PWM) sequences for illuminating and controlling spatial light modulators. Some examples provide a method of producing illumination light comprising a time-multiplexed sequence of a plurality of colors, the method including controlling a laser-phosphor light source to produce a first component of the illumination light during a plurality of first time periods, the first component of the illumination light including a first subset of the plurality of colors, and controlling a supplemental light source to produce a second component of the illumination light during a plurality of second time periods that are substantially non-overlapping with the plurality of first time periods, the second component of the illumination light including a second subset of the plurality of colors, the second subset including at least one color not present in the first subset. In some examples, the laser-phosphor light sources includes a laser, and controlling the laser-phosphor light source includes activating the laser to emit laser light for the plurality of first time periods and deactivating the laser for the plurality of second time periods. In some examples, controlling the supplemental light source includes activating at least one emitter of the supplemental light source for the plurality of second time periods and deactivating the at least one emitter for the plurality of first time periods. Thus, the laser-phosphor light source and the supplemental light source can be operated to emit their respective components of the illumination light during multiple mutually exclusive time periods of any given frame periods, to thereby display a time sequence of different colors (or wavelength ranges) of light. The plurality of first time periods may include multiple time periods of the same or different durations. Similarly, the plurality of second time periods may include multiple time periods of the same or different durations.

Further examples provide apparatus, devices and systems for implementing such methods and variations thereof, as described below.

### General Overview

In some projection display systems that employ a spatial light modulator, the display elements of the spatial light modulator are controlled between an “ON” state in which light is propagated towards a display so as to generate a bright image pixel on the display, and an “OFF” state in which light is propagated away from the display so as to result in a dark image pixel on the display. Control of the display elements of the spatial light modulator can be achieved through Pulse Width Modulation (PWM) sequencing in which the sequences describe time periods for which individual display elements are in the ON state and the OFF state. In some examples, the display system projects color images by sequentially illuminating the spatial light modulator with light of three or more primary colors (e.g., red, green, blue) within each frame period, so that the spatial light modulator sequentially projects images of these primary colors within that frame period. Assuming that the frame period is sufficiently short, the human eye will integrate the sequential primary color images into a single full-color-image. In some instances, one or more additional colors, such as yellow, for example, are used in combination with the three primary colors. Some projection display systems use color wheels (e.g., phosphor wheels and/or color filter wheels) to produce multiple illumination colors from a light source that emits light of a single color. For example, some projectors include a blue laser light source and use a phosphor wheel to produce yellow light from the blue light. Laser-phosphor light sources can offer advantages over other types of light sources in terms of achievable brightness. Some such systems may further include a color filter wheel to obtain red and green light from the yellow light, such that the system can produce an illumination beam for the spatial light modulator that includes all three primary colors.

In some examples, to sequentially illuminating the spatial light modulator with the different illumination colors, the system can be controlled to produce an illumination beam for the spatial light modulator in a pattern of different “time slots” of colors, individual time slots corresponding to the time for which the spatial light modulator is illuminated by a particular color. Where one or more color wheels are used, rotation of the color wheel(s) can result in the transitions between illuminating the spatial light modulator with one color of illumination light to illuminating the spatial light modulator with another color of illumination light being spread over time and over the dimension (e.g., width or height) of the spatial light modulator, leading to “mixed” color time slots in the illumination beam. For example, during a transition from red to green illumination, one region of the spatial light modulator may be illuminated with red light, while at the same time, another region of the spatial light modulator may be illuminated with the green light 246. Further, during a color transition, one or more regions of the spatial light modulator may be illuminated with a blend of red and green light (e.g., with some shade of yellow light, depending on the relative mix of red and green). These transitions, or mixed color time slots, are referred to as optical spokes. Spokes use up a certain amount of the frame period, reducing the time available for pure color time slots. This can limit the number of color cycles (e.g., number of color time slots and number transitions from one color to another) because each transition that produces a spoke uses up a portion of the frame period, causing the pure color time slots to be shorter, which in turn may reduce the PWM bit depth. However, certain applications may benefit from higher color cycles (which may reduce rainbow effects or other artifacts in a projected image) and/or only be able to support color time slots of a certain minimum duration (or require a certain minimum bit depth).

Accordingly, examples described herein provide techniques for reducing the presence or number of optical spokes during a frame period, thereby allowing for higher color cycles and high color to white light ratios through increased pure color time during a frame period. High color to white ratios, particularly red to white, for example, may advantageously improve image quality. Further, reducing spokes and allowing for an increased number of color cycles may allow greater flexibility in the PWM sequencing used to control the spatial light modulator, thereby also offering improved image quality (with fewer artifacts) and/or control over characteristics of a displayed image.

In some examples in which a laser-phosphor light source is used to produce one or more illumination colors, reducing spokes can be accomplished by using a supplemental light source that is independent of, but synchronized in operation with, the laser-phosphor light source. The two light sources can be operated to emit light during multiple mutually exclusive time periods during any given frame period, to thereby produce a time sequence of different colors (or wavelength ranges) of illumination light. In one example, an illumination system includes a laser-phosphor light source including a laser and a phosphor device, the laser configurable to emit, during a plurality of first time periods, laser light of a first color, and the phosphor device configurable to emit a phosphor emission of one or more second colors responsive to being illuminated by the laser light. The example illumination system further includes a supplemental light source configurable to produce, during a plurality of second time periods that are substantially non-overlapping with the plurality of first time periods, first source light of the first color. The example illumination system further includes a homogenizer (such as a light tunnel or fly’s eye array, for example) operable to produce an illumination beam based on the phosphor emission and the first source light, and a dichroic mirror positioned to reflect the first source light to the homogenizer and to transmit second source light to the homogenizer, the second source light based on the phosphor emission. The illumination system can be used to illuminate a spatial light modulator (or phase light modulator) that can be controlled using PWM sequences, for example.

These and other aspects are described in more detail below.

### Example System Architecture

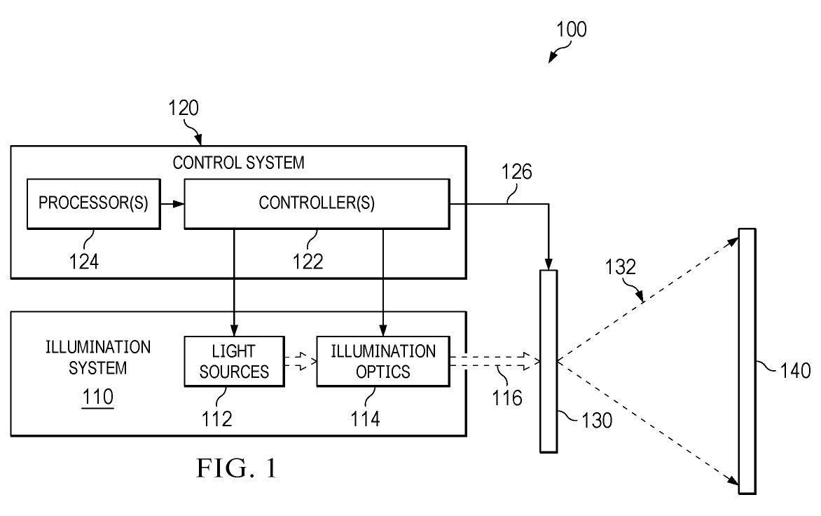

FIG. 1 is a block diagram of a display system 100 in accordance with various examples. The display system 100 includes an illumination system 110, a control system 120, and a spatial light modulator 130. The display system 100 may display images or video by projecting image frames at a certain frame rate onto a display 140 (e.g., a screen or a surface). In some examples, the illumination system 110 includes a light source 112 (e.g., one or more laser light sources, laser-phosphor light sources, light emitting diodes, etc.) and illumination optics 114 that are optically coupled to the light source 112. The illumination system 110 produces illumination light 116 (also referred to as an illumination beam). Examples of the illumination system 110, including the light source 112 and the illumination optics 114, are described below. The illumination system 110 can be configured to illuminate the spatial light modulator 130 with the illumination light 116. Thus, the spatial light modulator 130 can be optically coupled to the illumination system 110. The spatial light modulator 103, responsive to the illumination light 116 and under control of the control system 120, projects light 132 (also referred to as a projection beam, projected light, or projection light) onto the display 140. The display may be a display device, such as a screen of a computer, television, or other electronic device, or a display surface, such as a wall, roadway, canvas, or screen, to name a few examples. The projected light 132 is modulated by the spatial light modulator 130 to project still images or moving images (e.g., video) on the display 140.

The spatial light modulator 130 includes an array of display elements (not shown) for manipulating the incident illumination light 116 to form and project an image. The display elements form respective pixels of the image displayed on the display 140. In some examples, the spatial light modulator 130 may be a micro-electromechanical system (MEMS) device, such as a digital micromirror device (DMD) in which the display elements are micromirrors having adjustable movements for directing by reflection, modulating, and combining the illumination light 116 from the illumination system 110 into the projected light 132. In other examples, the spatial light modulator 130 may be liquid crystal display (LCD) device, or liquid crystal on silicon (LCoS) display device.

In some examples, the control system 120 includes at least one controller 122 and one or more processor(s) 124. The controller(s) 122 are coupled to the spatial light modulator 130 and configurable to control the display elements of the spatial light modulator 130 according to image data representing the image to be displayed on the display 140. In some examples, control signals 126 produced by the controller(s) 122 for controlling the display elements of the spatial light modulator 130 carry image data that represents modulated image frames according to PWM. The control signals 126 adjust the display elements of the spatial light modulator 130 to modulate the illumination light 116 and thereby shape the projected light 132 and form the image onto the display 140.

According to certain examples, the controller(s) 122 further may control one or more components of the illumination system 120. For example, the controller(s) 122 may control the light source 112 to emit the illumination light 116 and may control one or more elements of the illumination optics 114 to condition the illumination light 116. For example, the illumination optics 114 may include one or more rotatable color wheels, and the controller(s) 122 may control a rate of rotation of the color wheel(s), for example. In the example shown in FIG. 1, the controller(s) 122 are shown coupled to the light source 112, the illumination optics 114, and the spatial light modulator 130. However, in other examples, the control system 120 may include one or more additional controllers (not explicitly shown in FIG. 1) for controlling components of the illumination system 110 and/or the spatial light modulator 130. In some such examples, the processor(s) 124 may control synchronization among the controller(s) 122 and any additional controllers. In some examples, the processor(s) 124 may process the image data that is used by the controller 122 to produce the control signals 126 for the spatial light modulator 130, for example. In some examples, the control system 120 further includes one or more memory components or other processor-readable storage devices (not explicitly shown in FIG. 1) for storing executable program instructions for the processor(s) 124.

As used herein, the term “processor” describes circuitry that executes a function, an operation, or a sequence of operations. The function, operation, or sequence of operations can be hard coded into the circuitry or soft coded by way of instructions held in a memory device and executed by the circuitry. In some examples, the processor(s) 124 include one or more digital processors; however, the processor(s) 124 can be analog, digital, or mixed. As such, the processor(s) 124 can execute the function, operation, or sequence of operations using digital values and/or using analog signals. In some examples, the processor(s) 124 can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), or multicore processors. Examples of the processor(s) 124 that are multicore can provide functionality for parallel, simultaneous execution of instructions or for parallel, simultaneous execution of one instruction on more than one piece of data.

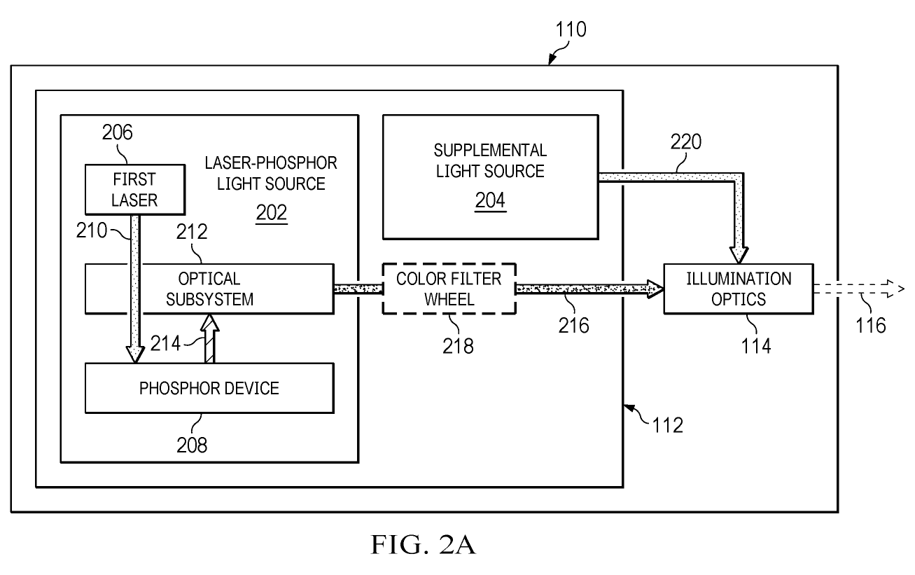

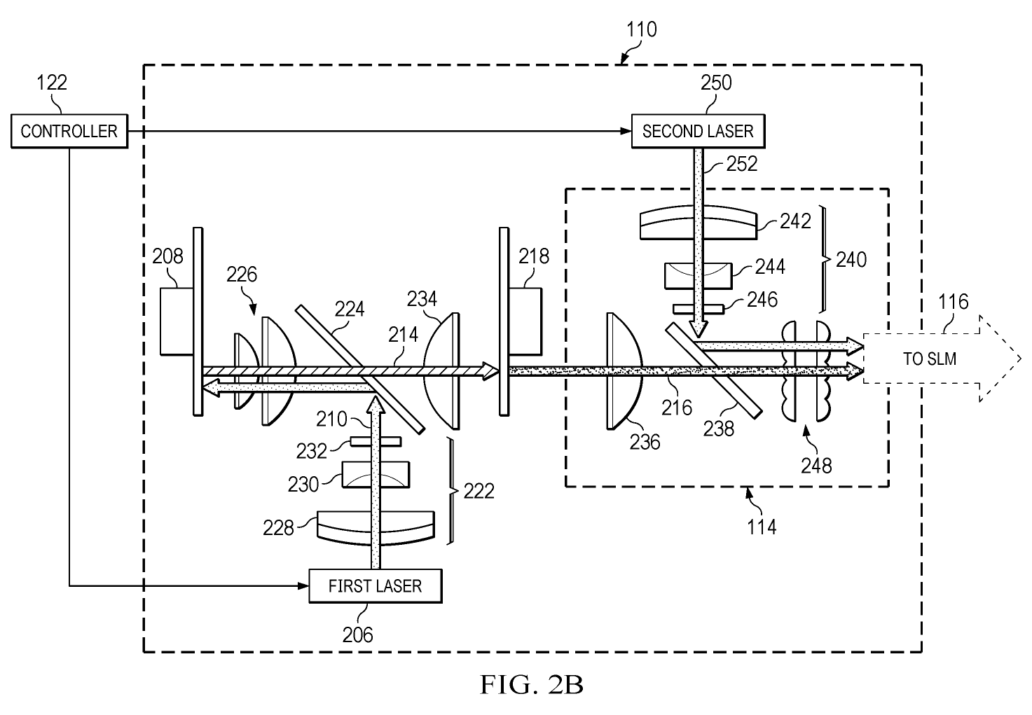

Referring to FIG. 2A, illustrated is an example of the illumination system 110. In this example, the light source 112 includes a laser-phosphor light source 202 and a supplemental light source 204. The laser-phosphor light source 202 includes a first laser 206 (e.g., one or more laser diodes or banks thereof) and a phosphor device 208. In some instances, the supplemental light source 204 includes a second laser; however, in other examples, the supplemental light source 204 may include another type of light emitter, such as one or more light emitting diodes (LEDs) or banks thereof. The first laser 206 emits laser light 210. In some examples, the first laser 206 is a blue laser diode that emits blue laser light 210; however, in other examples, the laser light 210 may be of a different color. Accordingly, for simplicity, examples described below refer to blue laser light 210 from the first laser 206; however, it will be appreciated that the techniques and principles described herein are not limited to blue laser light and may be applied to other colors.

The laser light 210 from the first laser 206 is directed to the phosphor device 208 via an optical subsystem 212. Thus, the first laser 206 may be optically coupled to the phosphor device 208 via the optical subsystem 212. The optical subsystem 212 may include a variety of optical elements, such as one or more mirrors, lenses, prisms, homogenizers, and/or combinations thereof, some examples of which are described below. For ease of description, the optical subsystem 212 is described and illustrated conceptually as being part of the laser-phosphor light source 202; however, in other examples, the optical subsystem 212 may be separate from the laser-phosphor light source 202. The phosphor device 208 may include one or more phosphor regions that comprise a phosphor. When illuminated by the laser light 210, the phosphor may be stimulated to produce an emission 214 (also referred to as a phosphor emission). In some examples, the phosphor produces yellow light as the emission 214 responsive to stimulation by blue laser light 210. However, in other examples, the phosphor may produce the emission 214 of a different color.

According to certain examples, the laser-phosphor light source 202 outputs source light 216 that is directed from the optical subsystem 212, optionally via a color filter wheel 218, to the illumination optics 114. In some examples (e.g., where the color filter wheel 218 is omitted), the source light 216 corresponds to the phosphor emission 214. In examples in which the light source 112 includes the color filter wheel 218, the source light 216 may be comprised of multiple colors (or wavelength ranges) of light produced from the phosphor emission 214 by the color filter wheel 218, and optionally also including the phosphor emission 214. The supplemental light source 204 produces supplemental source light 220 that is also directed to the illumination optics 114. The illumination system 110 thus outputs, via the illumination optics 114, the illumination light 116, which may be a time-multiplexed combination of the source light 216 and the supplemental source light 220, as described further below.

FIG. 2B illustrates a portion of the system 100 of FIG. 1, showing an example of an optical implementation of the illumination system 110 of FIG. 2A. In the example of FIG. 2B, the blue laser light 210 from the first laser 206 is transmitted via first optics 222 to a first dichroic mirror 224 that reflects the blue laser light 210 via second optics 226 to the phosphor device 208. In the illustrated example, the first optics 222 includes a first lens 228, a second lens 230, and a diffuser 232. The first and second lenses 228, 230 may act as beam reducing optics for the blue laser light 210. In other examples, the first and second lenses 228, 230 may be replaced with one or more other optical elements, such as mirrors or other lenses, that together perform the beam reducing function. In some examples, the diffuser 232 is a laser beam spot diffuser/shaper, such as a microlens array, for example. The second optics 226 may comprise focusing and/or collecting optics that focuses the blue laser light 210 onto a surface of the phosphor device 208. In the illustrated example, the second optics 226 includes a pair of lenses; however, in other examples, the second optics 226 may include one or more mirrors, lenses, or a combination thereof.

As described above, in some examples, responsive to illumination by the blue laser light 210, the phosphor device 208 produces the yellow phosphor emission 214. In the example of FIG. 2B, the phosphor device 208 is reflective, and thus the second optics 226 direct the phosphor emission 214 to the first dichroic mirror 224. The first dichroic mirror 24 may thus be configured to reflect the blue laser light 210 to the second optics 226, and to transmit the yellow phosphor emission 214 towards third optics 234, which in turn direct the phosphor emission 214 to the color filter wheel 218, as shown in FIG. 2B. However, in other examples, the phosphor device 208 may be transmissive, in which case another optical arrangement can be used to direct the phosphor emission 214 to the color filter wheel 218. Further, although the third optics 234 are represented in FIG. 2B by a lens, in other examples, the third optics 234 may include one or more mirrors, lenses, or a combination thereof.

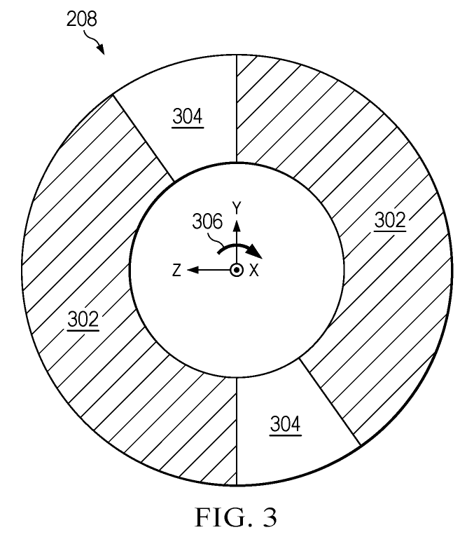

FIG. 3 shows a plan view of the phosphor device 208, according to an example. In this example, the phosphor device 208 is a rotatable phosphor wheel. In this example, the phosphor device 208 has an annular surface that includes one or more phosphor regions 302 comprising a phosphor that emits the yellow light 220 responsive to illumination by the blue light 206. In some examples, the phosphor device 208 further includes one or more clear regions 304 that do not comprise the phosphor. However, in other examples, the clear region(s) 304 are omitted. In some examples, the clear region(s) 304 may allow the blue laser light 210 to pass through (e.g., to a light trap or to an optical element, such as a mirror or lens, as described below), and as such may be composed of an optically transparent material, optionally with an anti-reflective coating. The phosphor device 208 is rotatable about a center axis, as indicated by arrow 306, such that the phosphor regions 302 and the clear region(s) 304 are sequentially positioned in the optical path of the blue laser light 210 as the phosphor device 208 rotates. It should be noted that while the phosphor device 208 is illustrated in FIG. 3 as having two phosphor regions 302 two clear regions 304, the phosphor device 208 may have an additional number of either regions, and need not have the same number of phosphor regions 302 as clear regions 304. As noted above, in some examples, the phosphor device 208 may omit the clear region(s) 304, such that substantially an entirety of the annular surface of the phosphor device 208 has the phosphor present.

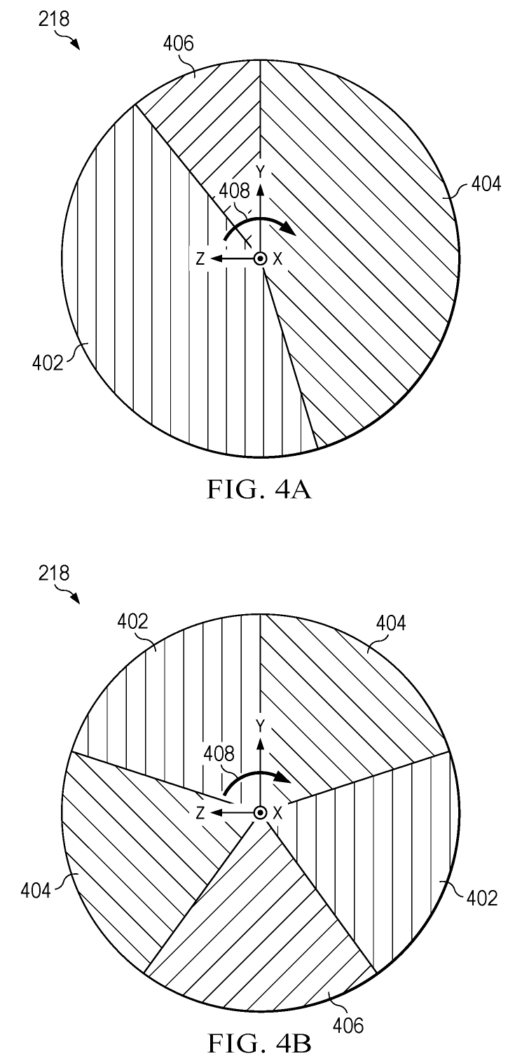

According to certain examples, the color filter wheel 218 is configured to produce, from the phosphor emission 214, the first source light 216 having one or more colors (or wavelength ranges). For example, the color filter wheel 218 may include one or more red or magenta filters that transmit red light and/or one or more green or cyan filters that transmit green light. Thus, when the yellow phosphor emission 214 is incident on a magenta filter of the color filter wheel 218, the red component of the yellow light may be transmitted to produce a red portion (or time slot) in the first source light 216. Similarly, when the yellow phosphor emission 214 is incident on a cyan filter of the color filter wheel 218, the green component of the yellow light may be transmitted to produce a green portion (or time slot) in the first source light 216. FIG. 4A is a plan view of a surface of the color filter wheel 218, according to an example. In this example, the color filter wheel 218 includes a red-transmitting segment (or region) 402 (e.g., a bandpass filter that transmits red light), a green-transmitting segment 404 (e.g., a bandpass filter that transmits green light), and a yellow-transmitting region 406. In some examples, the yellow-transmitting region 406 is a clear or optically transparent region, or may include a yellow-transmitting filter. In other examples, the color filter wheel 218 may include one or more red-transmitting regions 402, one or more green-transmitting regions (not necessarily the same number as red-transmitting regions), and optionally one or more regions that transmit one or more other colors (or wavelength ranges) of light, such as yellow and/or other colors. For example, FIG. 4B illustrates another example in which the color filter wheel 218 includes two red-transmitting regions 402, two green-transmitting regions 404, and a yellow-transmitting region 406. Thus, as the color filter wheel 218 rotates about an axis of rotation (as indicated by arrow 408), the first source light 216 can be produced (from the yellow phosphor emission 214) having a pattern of red, green, and yellow time slots. According to certain examples, the color filter wheel 218 rotates in synchronism with the speed of operation of the spatial light modulator 130 to project the red, green, and optionally yellow light for integration (with the blue time slots produced using the supplemental light source 204) into a composite color image on the display 140. The color filter wheel 218 may rotate (as indicated by arrow 408 in FIGS. 4A and 4B) about a center axis (shown as axis 410 in FIGS. 4A and 4B), thereby changing the positions of the color-transmitting regions 402, 404, 406 in the optical path between the phosphor device 208 and illumination optics 114. Rotational speed of the color filter wheel 218 may be controlled by the controller 122, for example. The color filter wheel 218 may rotate at speeds of 60Hz, 120Hz, 180Hz or higher, for example. It will be appreciated that colors and/or sizes of the various segments or regions of the color filter wheel 218 can vary widely, and are not limited to the examples shown in FIGS. 4A and 4B. Further, the number of segments/regions may be much higher than the three segments illustrated in FIG. 4A or the five segments shown in FIG. 4B.

Referring again to FIGS. 2A and 2B, the controller 122 can be configured to control the first laser 206 and a second laser 250, which as described above, may be part of the supplemental light source 204, in a time-synchronized manner. In some examples, the second laser 250 may emit supplemental laser light 252, which may correspond to, or may be a component of, the supplemental source light 220. The supplemental laser light 252 may have a same color (or wavelength range) as the laser light 210 emitted by the first laser 206. Thus, in some examples, the first laser 206 emits the blue laser light 210, as described above, and the second laser 250 emits blue supplemental laser light 252. Accordingly, for the time periods of a frame period when it is desired to illuminate the spatial light modulator 130 (FIG. 1) with red, green, or yellow light, the controller 122 may operate the first laser 206 to turn on and emit the blue laser light 210, which is converted to yellow, green, or red light via the phosphor device 208 and the color filter when 218, as described above. During such time periods, the controller 122 may control the second laser 250 of the supplemental light source 204 to remain off, and thus not emit the blue supplemental laser light 252. In contrast, during the time periods of the frame period when it is desired to desired to illuminate the spatial light modulator 130 with blue light, the controller 122 may turn off the first laser 206, and operate the supplemental light source 204 to turn on the second laser 250 to emit the blue supplemental laser light 252.

Accordingly, during one or more first time periods (while the second laser 250 is turned off or not emitting), the controller 122 controls the first laser 206 to emit the blue laser light 210. As described above, the blue laser light 210 is directed to the phosphor device 208, via the first optics 222, the first dichroic mirror 224, and the second optics 226. Responsive to illumination by the blue laser light 210, the phosphor device 208 produces the yellow phosphor emission 214. With a reflective phosphor configuration, as illustrated in FIGS. 2A and 2B, the yellow phosphor emission 214 is reflected from the phosphor device 208 back via the second optics 226 to the first dichroic mirror 224, which transmits the phosphor emission 214 to the color filter wheel 218. As the color filter wheel 218 rotates, the phosphor emission encounters a red-transmitting region 402, a green-transmitting region 404, or a yellow-transmitting region 406, such that the first source light 216 is produced as a sequence of red, green, and/or yellow time slots, as described above. During one or more second time periods, the first laser 206 can be turned off, and the supplemental light source 204 operated to turn on the second laser 250 to emit the blue supplemental laser light 252. The illumination optics 114 is configured to direct the first source light 216 and the blue supplemental laser light 252 towards the spatial light modulator, such that the illumination light 116 is produced as a sequence of red, green, yellow (during the first time period(s)), and blue (during the second time period(s)) time slots.

Continuing with the example of FIG. 2B, the illumination optics 114 may include elements that allow the coupling of the supplemental source light into the illumination light 116. For example, the illumination optics 114 may include a collimating lens 236, a second dichroic mirror 238, and a homogenizer 248. Rather than transmitting the first source light 216 directly to the homogenizer 248, the collimating lens 236 may expand the first source light 216 into a collimated space to allow insertion of the supplemental source light 220 via the second dichroic mirror. In the illustrated example, the condenser lens 236 directs the first source light 216 to the second dichroic mirror 238. The illumination optics 114 may further include fourth optics 240 that direct the blue supplemental laser light 252 to the second dichroic mirror 238. In some examples, the fourth optics 240 has the same configuration as the first optics 222, including a first lens 242 (which may have the same configuration and optical characteristics as the first lens 228), a second lens 244 (which may have the same configuration and optical characteristics as the second lens 230), and a laser beam spot diffuser/shaper 246 (e.g., a microlens array). However, in other examples, the fourth optics 240 may have a different configuration and may include any arrangement of lenses and/or mirrors (and/or optionally other optical elements) suitable to direct the blue supplemental laser light 252 to the second dichroic mirror 238. Further, in some examples, the second laser 250 may have a different configuration than the first laser 206, which may influence the configuration and/or components of the fourth optics 240. In some examples, if the blue supplemental laser light 252 has a beam shape that fits within the same etendue as the first source light 216, the fourth optics 240 may be omitted. In the example of FIG. 2B, the second dichroic mirror 238 reflects the blue supplemental laser light 252 towards the homogenizer 248 and transmits the first source light 216 towards the homogenizer 248. Accordingly, in this example, the second dichroic mirror 238 may be a blue-reflecting mirror that transmits other colors (or wavelength ranges) of light. The homogenizer 248 may be a light tunnel, fly’s eye array, or other type of homogenizer. In some examples in which the homogenizer 248 is a light tunnel, the illumination optics 114 may further include a condenser lens positioned optically before the light tunnel (e.g., between the second dichroic mirror 238 and the homogenizer 248) to focus the light into a small input aperture of the light tunnel.

In the examples of FIGS. 2A and 2B, because the rotating color filter wheel 218 can be used to produce the red and green (and optionally yellow) time slots, optical spokes may be produced at the transitions in the illumination light 116 from red to green illumination (or vice versa), from green to yellow illumination (or vice versa), and/or from red to yellow illumination (or vice versa), as described above. However, since the blue time slots in the illumination light 116 can be produced independently of the laser-phosphor light source 112 and/or the color filter wheel 218 by using the supplemental light source 204 as described above, with appropriate timing control, optical spokes can be avoided in transitions to or from blue illumination. For example, using optical spoke size information, the segmentation (e.g., arrangement of the various color-transmitting segments) the color filter wheel 218 can be sized such that, together with time-multiplexing of operation of the two independent lasers (206 and 250), optical spokes for the color(s) being produced using the second laser 250 (e.g., blue in the above-described example) can be avoided. In particular, by precisely controlling synchronized turning on and off of the first laser 206 and the second laser 250, the transitions to and from blue illumination, or blue time slots in the illumination light 116, can be almost instantaneous, such that optical spokes are not present. Furthermore, blue illumination from the second laser 250 may be introduced at transitions between non-blue colors, such as between red and green illumination (e.g., at a transition from red illumination to green illumination or vice versa). By precisely synchronizing turning on and off the first laser 206 and the second laser 250 during these transitions, the optical spokes (e.g., red-green spokes) that would otherwise be present at the transitions between other colors of illumination. The elimination of optical spokes advantageously reduces the total number of optical spokes in a given frame period and reduces the duration of the frame period that is lost to optical spokes. Further, in some PWM control schemes, blue time slots are shorter than red or green time slots, and therefore, spokes associated with blue transitions that reduce the time available for already short blue time slots can cause significant issues. For example, certain PWM sequences may be impractical because the blue time slots (accounting for spokes) are too short. Thus, the ability to remove optical spokes associated with blue transitions can be highly beneficial. Furthermore, since the second laser 250, and thus the optical path for blue illumination, is optically decoupled from the color filter wheel 218 (e.g., the blue supplemental laser light 252 does not pass through the color filter wheel 218), the color filter wheel 218 need not include segments for transmission of blue light (e.g., one or more blue-transmitting segments). This may advantageously reduce the number of segments present on the color filter wheel 218, allowing for higher color cycle rates as the color filter wheel 218 rotates.

In the configuration of FIGS. 2A and 2B, since the laser-phosphor light source is not used to produce the blue time slots in the illumination light 116, the phosphor device 208 may omit the clear region(s) 304, as described above. Further, in some such examples, the phosphor device 208 may be a stationary phosphor device, rather than a rotating phosphor wheel. These factors advantageously may allow for reductions in system costs associated with the phosphor device 208. For power efficiency, it may be preferable to turn the first laser 206 off while the second laser 250 is emitting the blue supplemental laser light 250, since any emission from the first laser 206 is not used to produce the blue time slots in the illumination light 116. However, in other examples, the first laser 206 may remain on and emitting the blue laser light 210 during the time periods for which the second laser 250 is active and emitting the blue supplemental laser light 252. In such examples, the phosphor device 208 may include the one or more clear regions 304, such that the unused blue laser light 210 can be transmitted through the clear region(s) 304 to a light trap or other “throw-away” path or element.

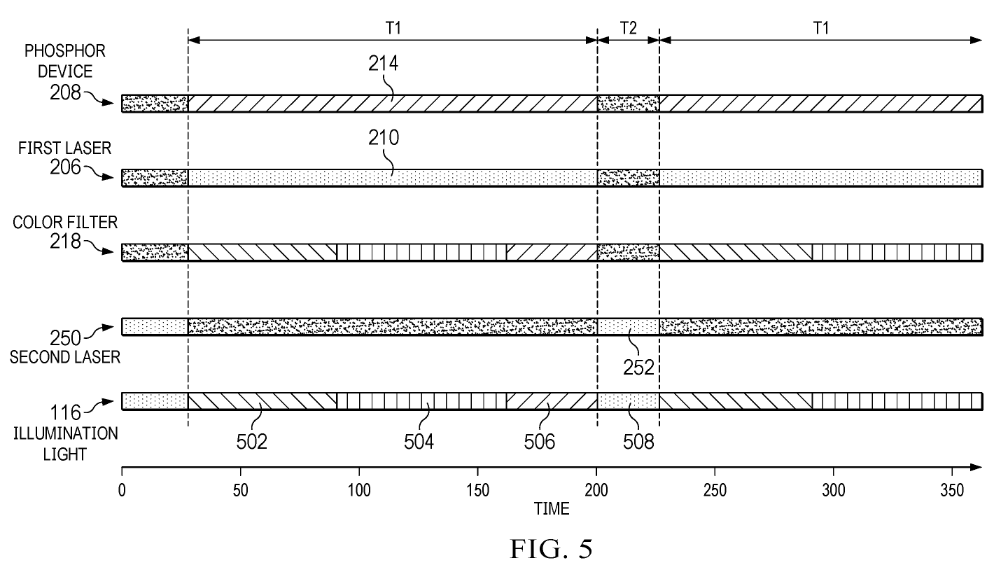

FIG. 5 is a diagram illustrating an example of color output from various elements and/or at various points in the illumination system 110 of FIGS. 2A and 2B. As described above, during a first time period, T1, the first laser 206 emits the blue laser light 210, and the phosphor device 208, responsive to illumination by the blue laser light 210, emits the yellow phosphor emission 214. In this example, the color filter wheel 218 may have the configuration shown in FIG. 4A, or a similar arrangement of color segments. Accordingly, during the first time period, T1, and as the color filter wheel 218 rotates, the yellow phosphor emission 214 sequentially encounters green-transmitting, red-transmitting, and yellow-transmitting regions of the color filter wheel 218, such that the color filter wheel 218 outputs green, red, and yellow light as shown. Accordingly, during the first time period, T1, the illumination light 116 includes a green time slot 502, a red time slot 504, and a yellow time slot 506. As described above, during the first time period, T1, the second laser 250 is turned off (e.g., under control of the controller 122) and produces no emission. During a second time period, T2, the first laser 206 is turned off (e.g., under control of the controller 122), and thus produces no emission. Accordingly, during the second time period, T2, since the phosphor device 208 does not receive illumination from the first laser 206, no phosphor emission is produced, and no illumination is output from the color filter wheel 218. During the second time period, T2, the second laser 250 is turned on (e.g., under control of the controller 122), and emits the blue supplemental laser light 252. Accordingly, during the second time period, T2, the illumination light 116 includes a blue time slot 508, as described above. Thus, using the arrangement of FIGS. 2A and 2B (or variations thereof), continuous (or substantially continuous) illumination light 116 can be produced with red, green, blue, and yellow time slots, by time-multiplexing operation of the first and second lasers 206, 250, as described above. In this manner, optical spokes associated with blue transitions can be eliminated. Furthermore, although not shown in FIG. 5, as described above, optical spokes associated with other color transitions (e.g., red-green) can be eliminated by turning off the first laser 206 and turning on the second laser 250 for a short transition period between color time slots, as described above.

As described above, use of the color filter wheel 218 in the illumination system 110 of FIG. 2A is optional. In the above-described examples, the phosphor device 208 can be used to produce the yellow phosphor emission 214, from which red and green light can be produced via the color filter wheel 218. However, in other examples, the color filter wheel 218 can be eliminated and the phosphor device can be configured to produce the phosphor emission 214 having one or more colors (or wavelength ranges) other than yellow. For example, the phosphor device 208 may have a configuration similar to that shown in FIG. 4B as an example of the color filter wheel 218. In such an example, the phosphor device may include one or more regions having a red phosphor (e.g., a phosphor that emits red light responsive to illumination from the first laser 206), one or more regions having a green phosphor (e.g., a phosphor that emits green light responsive to illumination from the first laser 206) and/or one or more regions having a yellow phosphor. In some such examples, the first laser 206 may emit the laser 210 having any suitable color (or wavelength range) as needed by the phosphor(s) to produce the phosphor emission 214 of the appropriate color/wavelength range. In some such examples, the first laser 206 may include more than one laser to allow for emission of the laser light 210 with different colors/wavelength ranges. As the phosphor device 208 rotates and is illuminated by the laser light 210 from the first laser 206, the phosphor device 208 may produce the phosphor emission 214 (and thus the first source light 216) having an arrangement of red, green, and/or yellow time slots, similar to as described above with respect to the output from the color filter wheel 218. With such a phosphor device 208, the color filter wheel 218 can be omitted. Blue time slots in the illumination light 116 may be produced using the supplemental light source 204, as described above. With such an arrangement, optical spokes associated with blue transitions may be eliminated through the use of the supplemental light source 204, as described above; however, optical spokes associated with red to/from green, green to/from yellow, and/or yellow to/from red transitions may still be present due to rotation of the phosphor device 208.

Thus, arrangements of the illumination system 110 of FIGS. 2A and 2B, with or without the color filter wheel 218 may produce the illumination light 116 having the color profile shown in FIG. 5, or variations thereof. It will further be appreciated that the color profile of the illumination light 116 may be altered by changing the number and/or arrangement of color segments on the phosphor device and/or color filter wheel (e.g., to change the number, durations, and/or sequence of red, green, and/or yellow times slots), and through varying the duration and/or number of time periods T1 and T2.

In the configurations of FIGS. 2A and 2B, the supplemental light source 204 (and second laser 250) are optically positioned after the color filter wheel 218 (i.e., the light emitted by the supplemental light source 204 does not pass through the color filter wheel 218), which allows for completely independent illumination relative to the first laser 206. Thus, first and second lasers 206, 250, respectively, can be operated in a mutually exclusive manner (i.e., one is turned on to emit while the other is turned off), allowing the transitions between illumination from one laser to illumination from the other to be almost instantaneous. Accordingly, optical spokes that would otherwise be associated with the transitions between illumination of one color and illumination of another color can be eliminated, as described above. By removing optical spokes associated with transitions from one illumination color to another, the time consumed by optical spokes, which uses up time available for the pure color time slots in a given frame period, is reduced, thereby advantageously offering several benefits. For example, longer pure color time slots may produce brighter illumination on the spatial light modulator 103, which in turn allows for a brighter projected image. Furthermore, longer pure color time slots may improve the color to white ratio, which can be an important metric in image projection systems. In particular, having a high red to white color ratio can be advantageous for high quality image projection. In some examples, to achieve higher brightness red illumination (and therefore a higher red to white ratio), the supplemental light source 204 may further include one or more red emitters, such as one or more red lasers (or banks thereof) or one or more red LEDs (or banks thereof). In such examples, the supplemental light source 204 can be operated, under control of the controller 122, for example, to turn on the red emitter(s) during red time slots. Thus, in such examples, during red time slots, both the first laser 206 and the red emitter(s) of the supplemental light source 204 may be active (emitting), such that the illumination light 116 includes contributions from both light sources. Such an arrangement may not reduce optical spokes associated with red transitions (since at least a portion of the red illumination is produced via the rotating phosphor device 208 and/or color filter wheel 218); however, it may improve the brightness of the red illumination. In further examples, the supplemental light source 204 can be configured to add illumination for one or more other colors (or wavelength ranges) instead of or in addition to red.

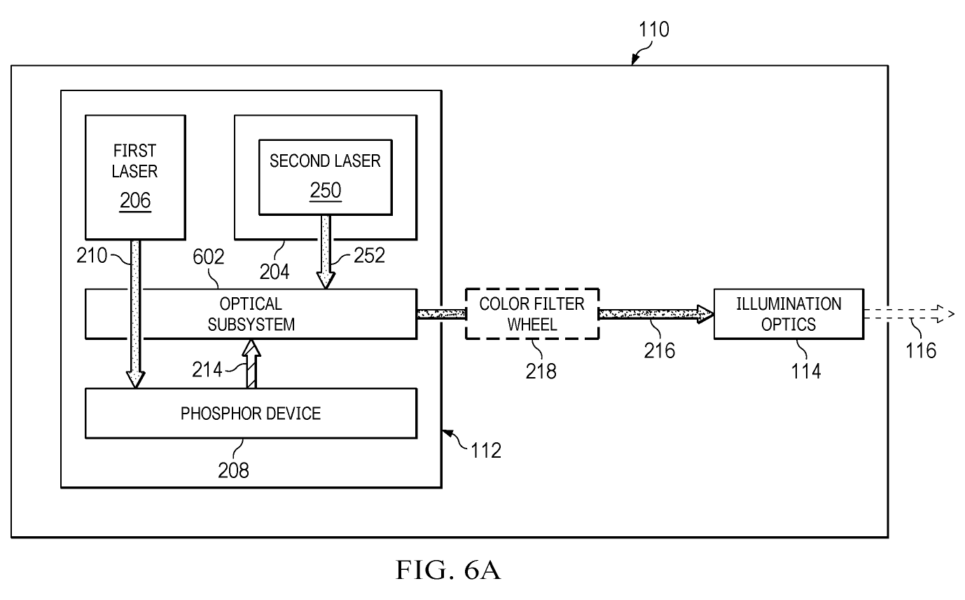

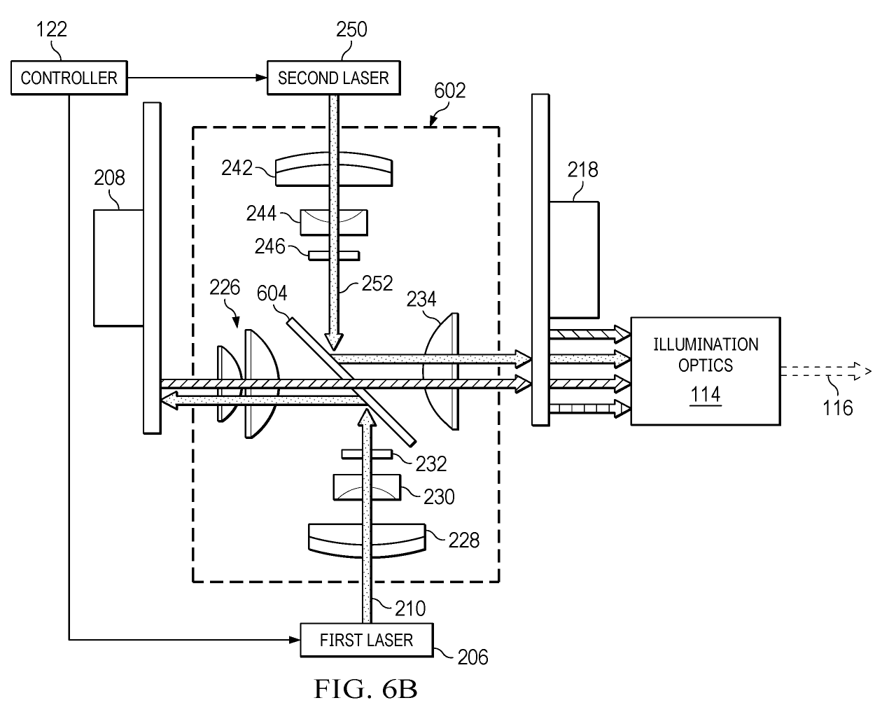

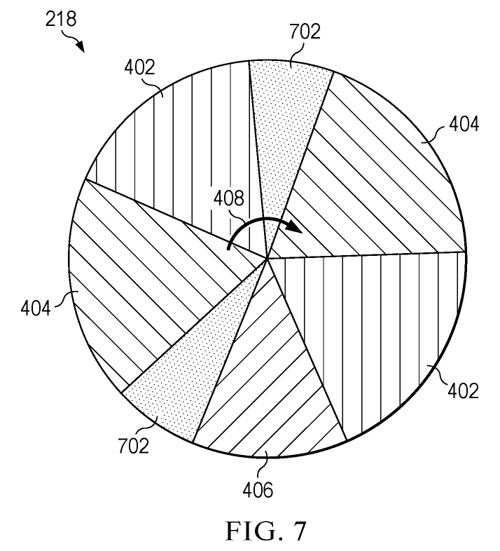

Turning to FIG. 6A, illustrated is another example of the illumination system 110. In this example, the light source 112 includes the first and second lasers 206, 250, which respectively emit the laser light 210 and the supplemental laser light 252. In some examples, the laser light 210 and the supplemental laser light 252 are blue light; however, in other examples they may have a different color/wavelength range. Accordingly, for simplicity, examples described below refer to blue laser light 210 from the first laser 206 and blue supplemental laser light from the second laser 250; however, it will be appreciated that the techniques and principles described herein are not limited to blue laser light and may be applied to other colors. An optical subsystem 602 is configured and arranged to direct the blue laser light 210 to the phosphor device 208, as described above. As also described above, responsive to illumination by the blue laser light 210, the phosphor device 208 may produce a yellow phosphor emission 214. The optical subsystem 602 is further configured and arranged to direct the phosphor emission 214 and the supplemental blue laser light 252 to the illumination optics 114 to produce the illumination light 116. The illumination system 110 of FIG. 6A may optionally include the color filter wheel 218 to produce one or more other colors (or wavelength ranges) of light from the phosphor emission 214, as described above. Although the optical subsystem 602 is illustrated in FIG. 6A as being part of the light source 112, it will be appreciated that in some instances or implementations, the optical subsystem 602 (or some components thereof) may be considered part of the illumination optics rather than the light source 112.

FIG. 6B illustrates a portion of the system 100 of FIG. 1, showing an example of an optical implementation of the illumination system 110 of FIG. 6A. In the example of FIG. 6B, the blue laser light 210 from the first laser 206 is transmitted via the first lens 228, the second lens 230, and the laser beam spot diffuser/shaper 232 to a dichroic mirror 604, as described above with reference to FIG. 2B. As noted above, the first and/or second lenses 228, 230 may be replaced with one or more other optical elements, such as mirrors and/or other lenses. The blue laser light 210 is reflected from the dichroic mirror 604, and directed towards the phosphor device 208 via the second optics 226, as also described above. In the example of FIG. 6B, the phosphor device 208 is reflective, and thus the second optics 226 further direct the phosphor emission 214 to the dichroic mirror 224. In the example of FIG. 6B, the illumination system 110 includes the color filter wheel 218, and therefore, as in the example of FIG. 2B, the phosphor emission 214 is transmitted through the dichroic mirror 604 and via the third optics 234 to the color filter wheel 218.

In the example of FIG. 6B, the blue supplemental laser light 252 is directed to the dichroic mirror 604 via the first lens 242, the second lens 244, and the laser beam spot diffuser/shaper 246, as described above with reference to FIG. 2B. However, in the arrangement of FIG. 6B, the first lens 242, the second lens 244, and the laser beam spot diffuser/shaper 246 form part of the optical subsystem 602 rather than the illumination optics 114. However, as described above, in some instances or implementations, the optical subsystem 602 itself (or at least some components thereof) may be considered part of the illumination optics 114. In the arrangement of FIG. 6B, the blue supplemental laser light 252 is reflected from the dichroic mirror 604 via the third optics 234 to the color filter wheel 218. Accordingly, in this example, the color filter wheel 218 may be configured to allow passage of the blue supplemental laser light 252 through to the illumination optics 114, to allow the illumination light 116 to include one or more blue time slots, as described above.

For example, referring to FIG. 7, the color filter wheel includes one or more blue-transmitting regions 702. In some examples, the blue-transmitting regions 702 are clear or optically transparent regions; however, in other examples, the blue-transmitting regions may include a blue-transmitting filter. Similarly, as described above, the yellow-transmitting region 406 may be an optically transparent region or may include a yellow-transmitting filter. Thus, in some instances, blue and/or yellow light may pass unfiltered through the respective segments 702, 406, of the color filter wheel 218.

Continuing with the example of FIGS. 6A and 6B, the controller 122 can be configured to control the first laser 206 and the second laser 250 in synchrony, such that when the first laser 206 is emitting the blue laser light 210, the second laser 250 is turned off, and vice versa. By precisely controlling and synchronizing the operation of the first and second lasers 206, 250, respectively, and controlling the rate(s) of rotation of the phosphor device 208 and/or the color filter wheel 218, the transitions to and from blue illumination (provided via the second laser 250) and other colors of illumination (provided via the first laser 206, the phosphor device 208, and optionally the color filter wheel 218) can be made almost instantaneous, thereby avoiding optical spokes associated with blue transitions. Thus, even though in the arrangement of FIG. 6B, the blue supplemental laser light 252 traverses an optical path that (optionally) includes the color filter wheel 218, the blue optical path is optically decoupled from the phosphor device 208 and optical spokes associated with blue transitions can be avoided by using the second laser 250.

In some examples, since the phosphor device 208 is not used to produce the blue time slots in the illumination light 116 (which are instead produced via the second laser 250), the phosphor device 208 may omit the clear region(s) 304, as described above. Further, in some such examples, the phosphor device 208 may be a stationary phosphor device, rather than a rotating phosphor wheel. As also described above, while, for power efficiency, it may be preferable to turn the first laser 206 off while the second laser 250 is emitting the blue supplemental laser light 252, it is also possible to allow the first laser 206 to may remain on and emitting the blue laser light 210 during the time periods for which the second laser 250 is active and emitting the blue supplemental laser light 252. In such examples, the phosphor device 208 may include the one or more clear regions 304, such that the unused blue laser light 210 can be transmitted through the clear region(s) 304 to a light trap or other “throw-away” path or element.

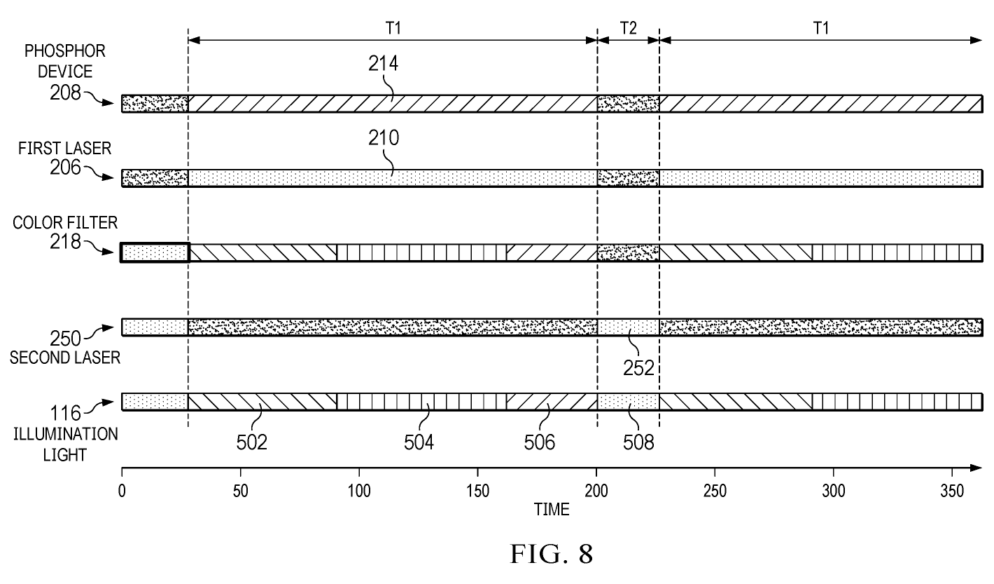

FIG. 8 is a diagram illustrating an example of color output from various elements and/or at various points in the illumination system 110 of FIGS. 6A and 6B. As may be seen with reference to FIGS. 5 and 8, in some examples, an optical arrangement of FIGS. 6A and 6B, while different from that of FIGS. 2A and 2B, can produce the same (or similar) pattern of color time slots in the illumination light 116. As described above, during the first time period, T1, the first laser 206 emits the blue laser light 210, and the phosphor device 208, responsive to illumination by the blue laser light 210, emits the yellow phosphor emission 214. In the example of FIG. 8, the color filter wheel 218 may have the configuration shown in FIG. 7, or a similar arrangement of color segments. Accordingly, during the first time period, T1, and as the color filter wheel 218 rotates, the yellow phosphor emission 214 sequentially encounters green-transmitting, red-transmitting, and yellow-transmitting regions of the color filter wheel 218, such that the color filter wheel 218 outputs green, red, and yellow light as shown. Accordingly, during the first time period, T1, the illumination light 116 includes the green time slot 502, the red time slot 504, and the yellow time slot 506, as described above. During the first time period, T1, the second laser 250 is turned off (e.g., under control of the controller 122) and produces no emission. During the second time period, T2, the first laser 206 is turned off (e.g., under control of the controller 122), and thus produces no emission. Accordingly, during the second time period, T2, since the phosphor device 208 does not receive illumination from the first laser 206, no phosphor emission is produced. During the second time period, T2, the second laser 250 is turned on (e.g., under control of the controller 122), and emits the blue supplemental laser light 252. Operation of the first and second lasers 206, 250 can be synchronized with rotation of the color filter wheel 218, such that, during the second time period, T2, the blue supplemental laser light 252 encounters a blue-transmitting region of the color filter wheel 218 and the color filter wheel 218 outputs blue light, as shown. Accordingly, during the second time period, T2, the illumination light 116 includes the blue time slot 508, as described above. Thus, using the arrangement of FIGS. 6A and 6B (or variations thereof), continuous (or substantially continuous) illumination light 116 can be produced with red, green, blue, and yellow time slots, by time-multiplexing operation of the first and second lasers 206, 250, as described above. In this manner, optical spokes associated with blue transitions can be eliminated.

In the arrangement of FIGS. 6A and 6B, the color filter wheel 218 is optional, and red and/or green light may be produced using a multi-color phosphor device 208, as described above. Such an arrangement may produce the same pattern of the illumination light 116 as illustrated in FIG. 8, and variations thereof. The blue illumination path from the second laser 250 remains optically decoupled from the phosphor device 208 and the optical path of the phosphor emission 214, such that optical spokes associated with blue transitions can be avoided.

As described above, in certain arrangements of FIGS. 2A and 2B, because the blue supplemental laser light 252 does not travel through the color filter wheel 218, the color filter wheel need not include a blue-transmitting region. However, the arrangements of FIGS. 2A and 2B are compatible with a color filter wheel 218 that does include one or more blue-transmitting segments, such as the example shown in FIG. 7. In such an example, the rotation rate of the color filter wheel 218 can be controlled such that the blue-transmitting segments 702 are aligned with the phosphor device 208 (e.g., positioned in what would be the optical path of the phosphor emission 214) during the times at which the first laser 206 is turned off and the second laser 250 is emitting the blue supplemental laser light 252. In such a configuration, no light would be passing through the color filter wheel 218 during the blue time slots. Such an arrangement may allow the use of a color filter wheel 218 having one or more blue-transmitting segments 702, even though those segments are not in use for production of the illumination light 116. This provides flexibility in the selection/use of available color filter wheels.

Further, in some examples, the supplemental light source 204 may include one or more supplemental emitters of a color other than blue, such as one or more red emitters (laser or LEDs), as described above. These supplemental emitter(s) can be used to increase the brightness of one or more colors of the illumination light, as described above, and thereby improved the color to white ratio(s) for that color or colors.

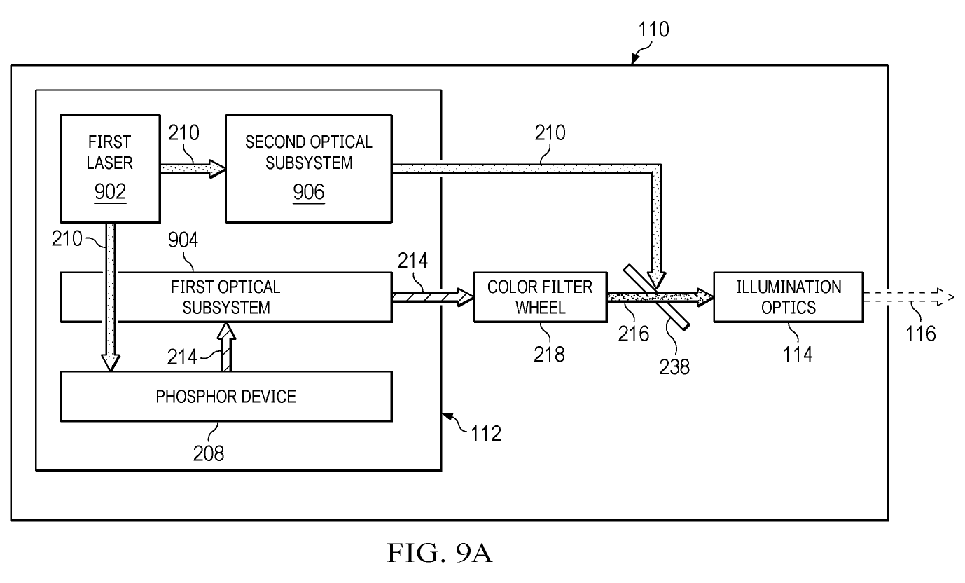

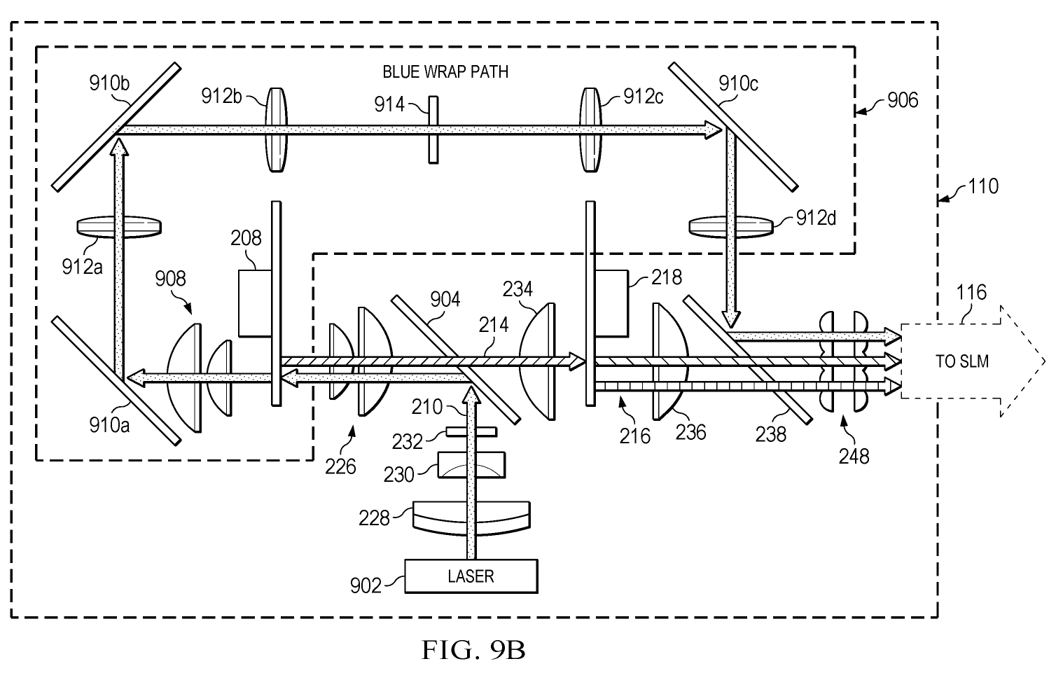

Turning to FIG. 9A, illustrated is another example of the illumination system 110. In this example, the light source 112 includes a laser 902 and the phosphor device 208. The laser 902 can be configured to emit the blue laser light 210, and the phosphor device 208 emits the phosphor emission (e.g., yellow and/or one or more other colors) responsive to being illuminated by the blue laser light 210 from the laser 902. As described above, in other examples, the laser 902 can be configured to emit laser light of another color, and therefore, while the following examples refer to the blue laser light 210, it will be appreciated that other colors/wavelength ranges can be used and the techniques and principles described herein are not limited to blue laser light. A first optical subsystem 904 is configured and arranged to direct the blue laser light 210 to the phosphor device 208, and to direct the phosphor emission 214 to the color filter wheel 218. In some examples, the first optical subsystem 902 has the same (or a similar) configuration as does the optical subsystem 212 of FIG. 2A. The color filter wheel 218 filters the phosphor emission 214 to produce the first source light 216 comprising time slots of multiple colors, based on rotation of the color filter wheel 218, as described above. A second optical subsystem 906 is configured and arranged to direct the blue laser light 210 to the second dichroic mirror 238. The second dichroic mirror 238 directs the first source light 216 output from the color filter wheel 218 to the illumination optics 114 and also directs the blue laser light 210 to the illumination optics 114, thereby producing the illumination light 116 comprising a time-multiplexed combination of the first source light 216 and the blue laser light 210. In the example of FIG. 9A, the optical path of the blue laser light 210 to the second dichroic mirror 238 is optically decoupled from the optical path of the phosphor emission 214 (and thus also of the first source light 216) through the inclusion of the second optical subsystem 906. Thus, optical spokes associated with blue transitions in the illumination light 116 can be avoided, even though only a single laser 902 (rather than the first and second lasers 206, 250 of FIGS. 2A-B and 6A-B) is used. It will be appreciated that although the first and second optical subsystems 904, 906 are illustrated in FIG. 6A as being part of the light source 112, one or both may be considered part of the illumination optics 114.

FIG. 9B illustrates an example of an optical implementation of the illumination system 110 of FIG. 9A. In the example of FIG. 9B, the blue laser light 210 from the laser 906 is transmitted via the first lens 228, the second lens 230, and the laser beam spot diffuser/shaper 232 to the first dichroic mirror 224, as described above with reference to FIG. 2B. As noted above, the first and/or second lenses 228, 230 may be replaced with one or more other optical elements, such as mirrors and/or other lenses. The blue laser light 210 is reflected from the first dichroic mirror 904 and directed towards the phosphor device 208 via the second optics 226, as also described above. In the example of FIG. 9B, the phosphor device 208 is reflective, and thus the second optics 226 further direct the phosphor emission 214 to the dichroic mirror 224. The phosphor emission 214 is transmitted through the first dichroic mirror 224, via the third optics 234, to the color filter wheel 218, as described above with reference to FIG. 2B.

As described above, as the color filter wheel 218 rotates, the incident phosphor emission 214 may encounter segments with different light-transmitting properties, such that the color filter wheel 218 produces, based on the phosphor emission 214, the first source light 216 having color time slots of different colors (or wavelength ranges). In the example illustrated in FIG. 9B, the color filter wheel 218 transmits red and green first source light 216. However, as described above, in other examples, the color filter wheel 218 may also include one or more segments that transmit the yellow phosphor emission 214, such that the first source light includes red, green, and yellow time slots. The first source light 216 is directed via the condenser lens 236 and the homogenizer 248 to form part of the outgoing illumination light 116, as described above.

In the example of FIG. 9B, the second optical subsystem 906 provides a “wrap-around” optical path for the blue laser light 210. Thus, in this example, the phosphor device may include the one or more clear regions 304 (FIG. 3) that lack the phosphor and allow passage of the blue laser light 210 to fourth optics 908. As noted above, the clear region(s) 304 (and other optical components) can be coated with an anti-reflective coating. Thus, in the context of FIG. 3 and the phosphor device 208, “clear” refers to the lack of phosphor. In the context of the color filter wheel 218, and in the case of a transmissive phosphor device 208, “clear” may also refer to optical transmission properties (e.g., a clear region may be optically transparent to at least certain wavelength ranges of light). Thus, as the phosphor wheel 208 rotates, the blue laser light 210 encounters either a phosphor region 302 (FIG. 3) or a clear region 304. When the blue laser light 210 encounters a phosphor region, the phosphor is stimulated to produce the phosphor emission 214, which is converted into the first source light 216 via the color filter wheel 218, as described above. When the blue laser light 210 encounters a clear region 304, the blue laser light is transmitted to the second optical subsystem 906, which directs the blue laser light 210 to the second dichroic mirror 238. Thus, the illumination light 116 comprises a time sequence of the first light 216 and the blue laser light 210 that is determined by rotation of the phosphor device 208 and the arrangement of phosphor region(s) 302 and clear region(s) 304 on the surface of the phosphor device 208. The sequence of colors in the portion of the illumination light 116 that corresponds to the first source light 216 is determined by the rotation of the color filter wheel 218 and the arrangement of color segments on the color filter wheel 218.

In the example of FIG. 9B, the second optical sub-system 906 includes the fourth optics 908, a set of mirrors 910, and a set of lenses 912. In this example, the blue laser light 210 transmitted via the phosphor device 208 and the fourth optics 908 is reflected from a first mirror 910a to a second mirror 910b, from the second mirror 910b to a third mirror 910c, and from the third mirror 910c to the second dichroic mirror 238, as shown. A first lens 912a of the set of lenses 912 is positioned between the first mirror 910a and the second mirror 910b, and optically couples the first mirror 910a to the second mirror 910b. Second and third lenses 912b and 912c, respectively, of the set of lenses 912 are positioned between the second and third mirrors 910b, 910c, respectively, and optically couple the second mirror 910b to the third mirror 910c. A fourth lens 912d of the set of lenses 912 is positioned between the third mirror 910c and the second dichroic mirror 238 to direct the blue laser light 210 onto the second dichroic mirror 238. In some examples, the second optical subsystem 906 includes a diffuser 914 positioned between the second and third lenses 912b, 912c, as shown. However, numerous other configurations are possible. For example, the diffuser 914 may be positioned at a different location in the wrap-around blue path. In another example, the third mirror 910 can be implemented as a reflective diffuser, serving both as a mirror and as the diffuser 914. In some examples, the fourth optics 908 has an opposite configuration to the second optics 226. For example, as described above, the second optics 226 may comprise focusing and/or collecting optics that focus the blue laser light 210 onto a surface of the phosphor device 208. In the illustrated example, the second optics 226 includes a pair of lenses. Accordingly, the fourth optics 908 may comprise a similar pair of lenses, arranged in the opposite direction/configuration with respect to the second optics 226, as shown. However, numerous other configurations may be implemented. Similarly, the second optical subsystem 906 may have various different configurations that function to direct the blue laser light 210 to the second dichroic mirror, and examples are not limited to the configuration shown in FIG. 9B.

The arrangement of the illumination system 110 shown in FIGS. 9A and 9B may offer a cost advantage in that only one laser 902 is used, rather than two lasers (e.g., the first laser 206 and the second laser 250 of FIGS. 2A-B and 6A-B). Further, control of the illumination system 110 may be simplified because the need to precisely synchronize operation of two (or more) lasers can be avoided. By providing a direct path for the blue laser light 210 to the homogenizer 248, separate from the optical path travelled by the phosphor emission 214 and bypassing the color filter wheel 218, optical spokes associated with blue transitions in the illumination light 216 are avoided, thereby providing the benefits as described above. In some examples, to increase the brightness of any one or more colors of the first source light 216, light from one or more supplemental emitters (e.g., lasers or LEDs) can be coupled into the blue path and added to the illumination light 116 similar to as described above.

Thus, certain aspects and examples provide an illumination system 110 that uses a first laser and a second laser that can be operated in an independent but synchronized, optionally mutually exclusive, (e.g., one laser is turned off while the other is turned on, and vice versa) manner to avoid optical spokes associated with the color(s) of illumination light produced using the second laser. Illumination from the second laser can be coupled into the illumination beam 116 for the spatial light modulator 130 either before or after the color filter wheel 218. In some examples, coupling the supplemental source light 204 into the illumination beam 116 after the color filter wheel 218 allows for higher flexibility in illumination by allowing for variable color duty cycles while using a color filter wheel 218 with a fixed duty cycle or fixed segmentation arrangement. Further examples avoid the use of a color filter wheel by using a multi-color phosphor device, as described above. Other aspects and examples provide a configuration for the illumination system in which a single laser is used, but an independent optical path is provided for at least one color (e.g., blue), to achieve the same benefit of avoiding optical spokes associated with the at least one color as in the examples using multiple independent lasers. By avoiding optical spokes, shorter pure color time slots and/or higher numbers of color cycles can be implemented in PWM sequences, which may provide benefits in terms of image quality (e.g., avoiding rainbow artifacts) and/or flexibility in the characteristics of images that can be displayed.

It will be appreciated that numerous variations of the optical arrangements illustrated in FIGS. 2B, 6B, and 9B are possible and may be implemented in other examples. Accordingly, the examples described and illustrated herein are intended to be explanatory and not limiting.

### Example Methodology

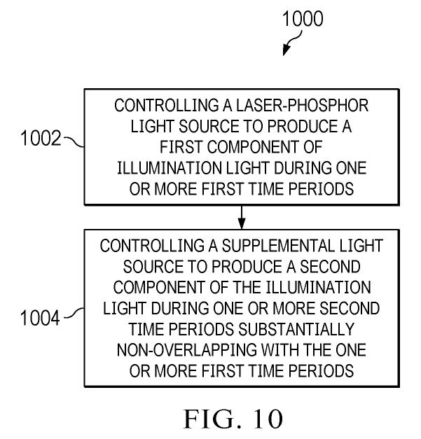

FIG. 10 is a flow diagram of a method 1000 of producing illumination light comprising a time-multiplexed sequence of a plurality of colors, according to an example. Aspects of the method 1000, and variations thereof, may be performed by the control system 120, for example, using examples of the illumination system 110 described herein.

The method 1000 may include an operation 1002 of controlling a laser-phosphor light source to produce a first component of the illumination light during one or more first time periods. The first component of the illumination light may include a first subset of the plurality of colors. As described above, in some examples, the laser-phosphor light sources includes a laser, and controlling the laser-phosphor light source includes activating the laser to emit laser light for the one or more first time periods.

The method 1000 may further include an operation 1004 of controlling a supplemental light source to produce a second component of the illumination light during one or more second time periods that are substantially non-overlapping with the one or more first time periods. The second component of the illumination light may include a second subset of the plurality of colors. The second subset may include at least one color not present in the first subset. In some examples, controlling the supplemental light source includes activating at least one emitter of the supplemental light source for the one or more second time periods.

Controlling the laser-phosphor light source at operation 1002 may further include deactivating the laser for the one or more second time periods. Controlling the supplemental light source at operation 1004 may further include deactivating the at least one emitter for the one or more first time periods. Thus, the laser and the at least one emitter can be operated independently to emit their respective components of the illumination light during multiple mutually-exclusive time periods during any given frame period.

According to certain examples, a method of producing the illumination light 116 comprising the time-multiplexed sequence of a plurality of colors includes activating the first laser 206 to emit first laser light 210 for a first time period (T1). During the first time period (T1), the method may include directing the first laser light 210 to the phosphor device 208 to stimulate the phosphor device 208 to produce the phosphor emission 208 responsive to the first laser light 210. During the first time period (T1), the method may further include outputting the illumination beam 116 based on the phosphor emission 214. According to certain examples, the method further includes, after the first time period (T1), deactivating the first laser 206 and activating the second laser 250 to emit the second laser light 252 for a second time period (T2), wherein the second laser 250 is deactivated during the first time period (T1). During the second time period, the method may include outputting the illumination beam 116 based on the second laser light 252, wherein the first laser 206 is deactivated during the second time period (T2). The first and second time periods, T1 and T2, may be repeated multiple times during a given frame period.

### Conclusion

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A circuit or device that is described herein as including certain components may instead be adapted to be coupled to those components to form the described circuitry or device.

Elements that are “optically coupled” have an optical path between them. For example, element A and element B are optically coupled if light may travel from element A to element B and/or light may travel from element B to element A. Being optically coupled does not require light to be actively propagating between the elements. Optically coupled elements are in an arrangement where light, if present, is capable of propagating from element A to element B or from element B to element A. Additionally, elements that are optically coupled may have additional elements, for example lenses, mirrors, prisms, light tunnels, or other optical elements, in the light path between them.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/- 10 percent of that parameter or +/- 5 percent of that parameter.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples described herein can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Further Examples

The following examples pertain to further arrangements and/or implementations, from which numerous permutations and configurations will be apparent.

Example 1 is an illumination system comprising: a laser-phosphor light source including a laser and a phosphor device, the laser configurable to emit, during one or more first time periods, laser light of a first color, and the phosphor device configurable to emit a phosphor emission of one or more second colors responsive to being illuminated by the laser light; a supplemental light source configurable to produce, during one or more second time periods substantially non-overlapping with the one or more first time periods, first source light of the first color; a homogenizer operable to produce an illumination beam based on the phosphor emission and the first source light; and a dichroic mirror positioned to reflect the first source light to the homogenizer and to transmit second source light to the homogenizer, the second source light based on the phosphor emission.

Example 2 includes the illumination system of Example 1, wherein the one or more second colors includes a plurality of second colors, the system further comprising: a color filter wheel operable to filter the phosphor emission to produce the second source light including the plurality of second colors.

Example 3 includes the illumination system of Example 2, wherein the first color is blue, and the plurality of second colors includes red, green, and yellow.

Example 4 includes the illumination system of one of Examples 2 or 3, wherein the dichroic mirror is a first dichroic mirror, the system further comprising: a second dichroic positioned in an optical path between the laser and the phosphor device and operable to reflect the laser light and to transmit the phosphor emission.

Example 5 includes the illumination system of any one of Examples 1-4, wherein the homogenizer is one of a light tunnel or a fly’s eye lens array.

Example 6 includes the illumination system of any one of Example 1-5, wherein the laser is a first laser, the laser light is first laser light, and the supplemental light source includes a second laser configurable to emit, during the second time period, the first source light as second laser light of the first color.

Example 7 includes the illumination system of any one of Examples 1-6, wherein the supplemental light source further comprises a red laser configurable to emit red laser light during at least one of the one or more second time periods and during at least a portion of the one or more first time periods.

Example 8 includes the illumination system of any one of Examples 1-7, wherein the laser-phosphor light source includes a plurality of lenses arranged in an optical path between the laser and the phosphor device.

Example 9 includes the illumination system of any one of Examples 1-8, wherein the phosphor device is a transmissive phosphor device.

Example 10 includes the illumination system of any one of Examples 1-8, wherein the phosphor device is a reflective phosphor device.

Example 11 is a method of producing illumination light comprising a time-multiplexed sequence of a plurality of colors, the method comprising: controlling a laser-phosphor light source to produce a first component of the illumination light during a plurality of first time periods, the first component of the illumination light including a first subset of the plurality of colors; and controlling a supplemental light source to produce a second component of the illumination light during a plurality of second time periods that are substantially non-overlapping with the plurality of first time periods, the second component of the illumination light including a second subset of the plurality of colors, the second subset including at least one color not present in the first subset; wherein the laser-phosphor light sources includes a laser; wherein controlling the laser-phosphor light source includes activating the laser to emit laser light for the plurality of first time periods and deactivating the laser for the plurality of second time periods; and wherein controlling the supplemental light source includes activating at least one emitter of the supplemental light source for the plurality of second time periods and deactivating the at least one emitter for the plurality of first time periods.

Example 12 includes the method of Example 11, wherein controlling the laser-phosphor light source includes, during the plurality of first time periods: controlling the laser to emit the laser light of the at least one color; and directing the laser light to a phosphor device to stimulate the phosphor device to produce a phosphor emission responsive to the laser light, the phosphor emission including one or more colors of the second subset of the plurality of colors.

Example 13 includes the method of one Example 12, further comprising: during the plurality of first time periods, directing the phosphor emission to a color filter; and filtering the phosphor emission with the color filter to produce the first component of illumination light.

Example 14 includes the method of Example 13, wherein the at least one color is blue; and wherein the first subset of the plurality of colors includes red, green, and yellow.

Example 15 includes the method of any one of Examples 11-14, wherein the at least one emitter of the supplemental light source is a blue laser, wherein the supplemental light source further includes a red laser, and wherein controlling the supplemental light source includes: controlling the red laser to emit red light during at least one of the second time periods and during at least a portion of the plurality of first time periods.

Example 16 is a system configured to implement the method of any one of Examples 11-15.

Example 17 is a light projection system comprising: an illumination subsystem configurable to produce an illumination beam, the illumination subsystem including a first laser configurable to emit first laser light, a phosphor device operable to produce a phosphor emission responsive being illuminated by the first laser light, a color filter operable to produce filtered light based on the phosphor emission from the phosphor device, and a second laser configurable to emit second laser light, the second laser being optically decoupled from the phosphor device and the color filter. The light projection system further comprises a controller coupled to the first laser and to the second laser, the controller configurable to control the first laser to emit the first laser light for a plurality of first time periods and to deactivate the first laser for a plurality of second time periods, and to control the second laser to emit the second laser light for the plurality of second time periods and to deactivate the second laser for the plurality of first time periods, to thereby produce the illumination beam as a time-multiplexed combination of the second laser light and the filtered light.

Example 18 includes the light projection system of Example 17, wherein: the first laser is a first blue laser and the first laser light is blue light; the phosphor device is operable to produce the phosphor emission as yellow light; the color filter is a color filter wheel having at least one first segment that transmits yellow light, at least one second segment that transmits green light, and at least one third segment that transmits red light, the color filter wheel operable to produce the filtered light as a time-multiplexed sequence of the yellow light, the red light, and the green light; and the second laser includes a second blue laser and the second laser light includes blue light.

Example 19 includes the light projection system of Example 18, wherein the second laser further includes a red laser configurable to emit red light; and wherein the second laser light includes a combination of the blue light emitted by the second blue laser and the red light emitted by the red laser.

Example 20 includes the light projection system of any one of Examples 17-19, wherein the illumination subsystem further includes: a first dichroic mirror positioned to the reflect the first laser light to the phosphor device and to allow transmission of the phosphor emission through the first dichroic mirror from the phosphor device to the color filter; and a second dichroic mirror positioned to reflect the second laser light toward an output of the illumination subsystem to produce a first component of the illumination beam, and to transmit the filtered light toward the output of the illumination subsystem to produce a second component of the illumination beam.

Example 21 includes the light projection system of Example 20, wherein the illumination subsystem further includes: first optics configured to direct the first laser light from the first laser to the first dichroic mirror; second optics positioned direct the first laser light from the first dichroic mirror to the phosphor device and to direct the phosphor emission from the phosphor device to the first dichroic mirror; and third optics positioned to direct the phosphor emission from the first dichroic mirror to the color filter.

Example 22 includes the light projection system of Example 21, wherein the third optics includes a condenser lens; and wherein the illumination subsystem further includes a re-collimating lens positioned between the color filter and the second dichroic mirror.

Example 23 includes the light projection system of any one of Examples 20-22, wherein the illumination subsystem further includes one or more optical elements positioned between the second laser and the second dichroic mirror.

Example 24 includes the light projection system of any one of Examples 20-23, wherein the illumination subsystem further includes a homogenizer arranged to receive the filtered light and the second laser light.

Example 25 includes the light projection system of any one of Examples 17-24, wherein the phosphor device is a transmissive phosphor device.

Example 26 includes the light projection system of any one of Examples 17-24, wherein the phosphor device is a reflective phosphor device.

Example 27 is a method comprising: activating a first laser to emit first laser light for a first time period; during the first time period, directing the first laser light to a phosphor device to stimulate the phosphor device to produce a phosphor emission responsive to the first laser light; during the first time period, outputting an illumination beam based on the phosphor emission; after the first time period, deactivating the first laser and activating a second laser to emit second laser light for a second time period, wherein the second laser is deactivated during the first time period; and during the second time period, outputting the illumination beam based on the second laser light, wherein the first laser is deactivated during the second time period.

Example 28 includes the method of Example 27, wherein the first laser light is blue laser light and wherein the second laser light is blue laser light.

What is claimed is:

1. An illumination system comprising:
a laser-phosphor light source including a laser and a phosphor device, the laser configurable to emit, during one or more first time periods, laser light of a first color, and the phosphor device configurable to emit a phosphor emission of one or more second colors responsive to being illuminated by the laser light;
a supplemental light source configurable to produce, during one or more second time periods substantially non-overlapping with the one or more first time periods, first source light of the first color;
a homogenizer operable to produce an illumination beam based on the phosphor emission and the first source light; and
a dichroic mirror positioned to reflect the first source light to the homogenizer and to transmit second source light to the homogenizer, the second source light based on the phosphor emission.

2. The illumination system of claim 1, wherein the one or more second colors includes a plurality of second colors, the system further comprising:
a color filter wheel operable to filter the phosphor emission to produce the second source light including the plurality of second colors.

3. The illumination system of claim 2, wherein the first color is blue, and the plurality of second colors includes red, green, and yellow.

4. The illumination system of claim 2, wherein the dichroic mirror is a first dichroic mirror, the system further comprising:
a second dichroic mirror positioned in an optical path between the laser and the phosphor device and operable to reflect the laser light and to transmit the phosphor emission.

5. The illumination system of claim 1, wherein the homogenizer is one of a light tunnel or a fly’s eye lens array.

6. The illumination system of claim 1, wherein the laser is a first laser, the laser light is first laser light, and the supplemental light source includes a second laser configurable to emit, during the one or more second time periods, the first source light as second laser light of the first color.

7. The illumination system of claim 1, wherein the supplemental light source further comprises a red laser configurable to emit red laser light during the one or more second time periods and during at least a portion of the one or more first time periods.

8. A method of producing illumination light comprising a time-multiplexed sequence of a plurality of colors, the method comprising:
controlling a laser-phosphor light source to produce a first component of the illumination light during a first time period, the first component of the illumination light including a first subset of the plurality of colors; and
controlling a supplemental light source to produce a second component of the illumination light during a second time period that is substantially non-overlapping with the first time period, the second component of the illumination light including a second subset of the plurality of colors, the second subset including at least one color not present in the first subset;
wherein the laser-phosphor light source includes a laser;
wherein controlling the laser-phosphor light source includes activating the laser to emit laser light for the first time period and deactivating the laser for the second time period; and
wherein controlling the supplemental light source includes activating at least one emitter of the supplemental light source for the second time period and deactivating the at least one emitter for the first time period.

9. The method of claim 8, wherein controlling the laser-phosphor light source includes, during the first time period:
controlling the laser to emit the laser light of the at least one color; and
directing the laser light to a phosphor device to stimulate the phosphor device to produce a phosphor emission responsive to the laser light, the phosphor emission including one or more colors of the first subset of the plurality of colors.

10. The method of claim 9, further comprising:
during the first time period, directing the phosphor emission to a color filter; and
filtering the phosphor emission with the color filter to produce the first component of illumination light.

11. The method of claim 10, wherein the at least one color is blue; and
wherein the first subset of the plurality of colors includes red, green, and yellow.

12. The method of claim 8, wherein the at least one emitter of the supplemental light source is a blue laser, wherein the supplemental light source further includes a red laser, and wherein controlling the supplemental light source includes:
controlling the red laser to emit red light during the second time period and during at least a portion of the first time period.

13. A light projection system comprising:
an illumination subsystem configurable to produce an illumination beam, the illumination subsystem including
a first laser configurable to emit first laser light,
a phosphor device operable to produce a phosphor emission responsive being illuminated by the first laser light,
a color filter operable to produce filtered light based on the phosphor emission from the phosphor device, and
a second laser configurable to emit second laser light, the second laser being optically decoupled from the phosphor device and the color filter; and
a controller coupled to the first laser and to the second laser, the controller configurable to control the first laser to emit the first laser light for a first time period and to deactivate the first laser for a second time period, and to control the second laser to emit the second laser light for the second time period and to deactivate the second laser for the first time period, to thereby produce the illumination beam as a time-multiplexed combination of the second laser light and the filtered light.

14. The light projection system of claim 13, wherein:
the first laser is a first blue laser, and the first laser light is blue light;
the phosphor device is operable to produce the phosphor emission as yellow light;
the color filter is a color filter wheel having at least one first segment that transmits yellow light, at least one second segment that transmits green light, and at least one third segment that transmits red light, the color filter wheel operable to produce the filtered light as a time-multiplexed sequence of the yellow light, the red light, and the green light; and
the second laser includes a second blue laser, and the second laser light includes blue light.

15. The light projection system of claim 14, wherein the second laser further includes a red laser configurable to emit red light; and
wherein the second laser light includes a combination of the blue light emitted by the second blue laser and the red light emitted by the red laser.

16. The light projection system of claim 13, wherein the illumination subsystem further includes:
a first dichroic mirror positioned to the reflect the first laser light to the phosphor device and to allow transmission of the phosphor emission through the first dichroic mirror from the phosphor device to the color filter; and
a second dichroic mirror positioned to reflect the second laser light toward an output of the illumination subsystem to produce a first component of the illumination beam, and to transmit the filtered light toward the output of the illumination subsystem to produce a second component of the illumination beam.

17. The light projection system of claim 16, wherein the illumination subsystem further includes:
first optics configured to direct the first laser light from the first laser to the first dichroic mirror;
second optics positioned direct the first laser light from the first dichroic mirror to the phosphor device and to direct the phosphor emission from the phosphor device to the first dichroic mirror; and
third optics positioned to direct the phosphor emission from the first dichroic mirror to the color filter.

18. The light projection system of claim 17, wherein the third optics includes a condenser lens; and wherein the illumination subsystem further includes a re-collimating lens positioned between the color filter and the second dichroic mirror.

19. The light projection system of claim 16, wherein the illumination subsystem further includes one or more optical elements positioned between the second laser and the second dichroic mirror.

20. The light projection system of claim 16, wherein the illumination subsystem further includes a homogenizer arranged to receive the filtered light and the second laser light.
